(19) United States
(12) Patent Application Publication
(10) Pub. No.: US 2026/0097804 A1
(43) Pub. Date: Apr. 9, 2026

(54) APPARATUS AND METHOD FOR CONTROLLING STEERING AND SPEED OF VEHICLE

(71) Applicants: Hyundai Motor Company, Seoul (KR); Kia Corporation, Seoul (KR)

(72) Inventor: Jang Shin Kim, Hwaseong (KR)

(21) Appl. No.: 19/227,781

(22) Filed: Jun. 4, 2025

(30) Foreign Application Priority Data
Oct. 8, 2024 (KR) 10-2024-0136535

(51) Int. Cl. B62D 5/04; B60K 7/00; B62D 15/02

(52) U.S. Cl. CPC B62D 5/0418; B60K 7/0007; B62D 5/046; B62D 15/0215; B62D 15/0235

(57) ABSTRACT

A method and an apparatus for controlling a vehicle can be applied to an in-wheel motor vehicle, including controlling a speed and steering for each wheel of the in-wheel motor vehicle. The method includes obtaining an input steering angle and a vehicle speed; determining a target steering angle for each wheel and a target frequency for each wheel based on the input steering angle and the vehicle speed using a lookup table; and controlling a steering device configured to perform the steering for each wheel of the vehicle and in-wheel motors mounted on each wheel of the vehicle based on the target steering angle for each wheel and the target frequency for each wheel.

### CROSS REFERENCE TO RELATED APPLICATION

The present application claims under 35 U.S.C. § 119 (a) the benefit of Korean Patent Application No. 10-2024-0136535, filed on Oct. 8, 2024, the entire contents of which is incorporated by reference herein.

### BACKGROUND

### (a) Technical Field

The present disclosure relates to a method and apparatus for controlling speed and steering of a vehicle, more particularly, to the method and apparatus for controlling a speed and steering of each wheel of an in-wheel motor vehicle.

### (b) Description of the Related Art

The following description merely provides background information related to the present embodiment and does not constitute prior art.

A rear wheel steering (RWS) system is a technology that actively controls a steering angle of rear wheels according to a steering angle of a front wheel according to a driving situation of a vehicle. The rear wheel steering system may improve agility at low speeds and stability at high speeds.

An in-wheel system is a configuration where in-wheel motors are installed within each wheel of the vehicle, enabling independent control of each wheel's drive. This system features a simplified drivetrain, offering excellent space efficiency. Additionally, as each wheel can be controlled independently, torque adjustment for each wheel is possible, which enhances the vehicle's driving performance.

In vehicles equipped with in-wheel motors, the speed of all wheels should be controlled equally during straight driving. However, during turning, the speed and steering angle of each wheel must be controlled independently. Additionally, in parking situations, the vehicle may experience sharp turning maneuvers, requiring timely and swift control of speed and steering for each wheel.

### SUMMARY

The present disclosure is directed to a method and apparatus for controlling the speed and steering of each wheel of an in-wheel motor vehicle in real time, e.g., by using a lookup table.

According to at least an exemplary embodiment of the present disclosure, a method for controlling a vehicle includes: obtaining, by a processor, an input steering angle and a vehicle speed of the vehicle; determining, by the processor, a target steering angle and a target frequency for each wheel of the vehicle based on the input steering angle and the vehicle speed using a lookup table; and controlling, by the processor, a steering device configured to perform steering of each wheel of the vehicle and motors mounted on each wheel of the vehicle based on the target steering angle for each wheel and the target frequency for each wheel.

According to another aspect, the present disclosure provide a method including: obtaining an input steering angle and a vehicle speed; determining a target steering angle for each wheel and a target frequency for each wheel based on the input steering angle and the vehicle speed using a lookup table; and controlling a steering device configured to perform the steering for each wheel of the vehicle and in-wheel motors mounted on each wheel of the vehicle based on the target steering angle for each wheel and the target frequency for each wheel.

The lookup table may be pre-generated by determining a steering angle factor for each wheel and a frequency factor for each wheel corresponding to a plurality of input steering angles, considering the vehicle's specifications.

The method may determine a frequency control value for each wheel using the target frequency for each wheel and the frequency measured for each wheel, and control the corresponding in-wheel motor based on the determined frequency control value.

The method may determine a steering angle control value for each wheel using the target steering angle for each wheel and the steering angle measured for each wheel, and control the corresponding steering device based on the determined steering angle control value.

According to the present disclosure, a non-transitory computer readable medium containing program instructions executed by a processor may include: program instructions that obtain an input steering angle and a vehicle speed of a vehicle; program instructions that determine a target steering angle for each wheel of the vehicle and a target frequency for each wheel based on the input steering angle and the vehicle speed using a lookup table; and program instructions that control a steering device configured to perform steering of each wheel of the vehicle and motors mounted on each wheel of the vehicle based on the target steering angle for each wheel and the target frequency for each wheel.

According to another exemplary embodiment of the present disclosure, an apparatus for controlling a vehicle includes: a communication unit; at least one processor; and a memory operably coupled with the at least one processor, wherein the at least one processor is configured to execute instructions to: obtain an input steering angle and a vehicle speed of the vehicle, determine a target steering angle for each wheel of the vehicle and a target frequency for each wheel based on the input steering angle and the vehicle speed using a lookup table, and control a steering device configured to perform the steering for each wheel of the vehicle and motors mounted on each wheel of the vehicle based on the target steering angle for each wheel and the target frequency for each wheel.

According to another aspect, the present disclosure provide an apparatus for controlling a speed and steering for each wheel of an in-wheel motor vehicle, the apparatus comprising: a communication unit; at least one processor; and a memory operably coupled with the at least one processor, wherein the memory stores a command that causes the at least one processor to perform operations in response to execution of a command by the at least one processor, and the operations include obtaining an input steering angle and a vehicle speed, determining a target steering angle for each wheel and a target frequency for each wheel based on the input steering angle and the vehicle speed using a lookup table, and controlling a steering device configured to perform the steering for each wheel of the vehicle and in-wheel motors mounted on each wheel of the vehicle based on the target steering angle for each wheel and the target frequency for each wheel.

A vehicle may include the above-described apparatus.

According to an aspect of the present disclosure, the stability and agility of in-wheel motor vehicles during turning can be improved by utilizing a lookup table to reduce real-time computational load.

The effects of the present disclosure are not limited to the effects mentioned above, and other effects not mentioned will be clearly understood by those skilled in the art from the following description.

### BRIEF DESCRIPTION OF THE DRAWINGS

FIG. 1 is an exemplary diagram illustrating a vehicle provided with some components of an apparatus for controlling a speed and steering of each wheel of the vehicle according to one embodiment of the present disclosure.

FIG. 2A, FIG. 2B and FIG. 2C are diagrams illustrating turning centers of vehicles according to the steering situations for each wheel.

FIG. 2D is an exemplary diagram of a process of calculating the center of turning of a vehicle based on steering angles of front and rear wheels.

FIG. 2E is a flowchart illustrating a process for determining whether to activate a rear wheel steering (RWS) function and selecting a steering direction (in-phase or opposite-phase), according to one embodiment of the present disclosure

FIG. 3 is a block diagram of an apparatus for controlling a speed and steering of each wheel of a vehicle according to one embodiment of the present disclosure.

FIG. 4 is a diagram illustrating a process of determining a wheel-specific steering angle wheel based on an input steering angle.

FIG. 5A and FIG. 5B are diagrams illustrating a lookup table according to one embodiment of the present disclosure.

FIG. 6 is a diagram illustrating a process of determining a maximum speed at which rollover does not occur based on a turning radius of the vehicle.

FIG. 7 is a flowchart of a method for controlling a speed and steering of each wheel of a vehicle according to one embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the following description, like reference numerals designate like elements, although the elements are shown in different drawings. Furthermore, for clarity and for brevity, the following description of various exemplary embodiments will omit a detailed description of related known components and functions when considered obscuring the subject of the present disclosure.

The description of the present disclosure to be presented below in conjunction with the accompanying drawings is directed to describe exemplary embodiments of the present disclosure and is not intended to represent the only embodiments in which the technical idea of the present disclosure may be practiced.

As used herein, the term “turning center” refers to a turning center point which is external to the vehicle and may be used interchangeably with the term “center of turning.” The term “turning radius” may be used interchangeably with the term “radius of turning.”

As used herein, the sign of a wheel-specific steering angle is negative when the wheel is steered to the right based on the vehicle's direction of travel, and positive when the wheel is steered to the left based on the vehicle's direction of travel.

The present disclosure relates to a technology for determining a steering angle and frequency for each wheel using a lookup table, and controlling steering and speed for each wheel of the vehicle based on the determined steering angle and frequency for each wheel. In the present specification, a vehicle equipped with a rear wheel steering system and/or an in-wheel system is described as an example, but it is not limited thereto.

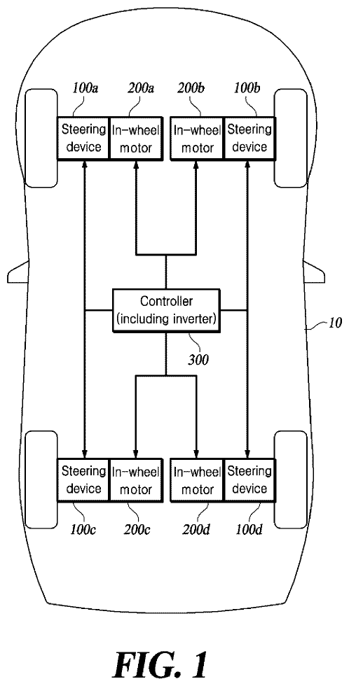

FIG. 1 is an exemplary diagram illustrating a vehicle provided with some components of an apparatus for controlling a speed and steering of each wheel of the vehicle according to one embodiment of the present disclosure

Referring to FIG. 1, a vehicle 10 according to one embodiment of the present disclosure is provided with steering devices 100a, 100b, 100c, 100d, in-wheel motors 200a, 200b, 200c, 200d, and a controller 300.

The steering devices 100a, 100b, 100c, 100d perform steering by receiving a wheel-specific steering angle inputted from the controller 300.

The in-wheel motors 200a, 200b, 200c, 200d are mounted on the internal side of the respective wheels of the vehicle 10 and are configured for accelerating and decelerating by receiving alternating current power of a wheel-specific power frequency from the controller 300.

The controller 300 determines a frequency and a steering angle for each wheel, based on a steering wheel rotation angle and a vehicle speed, using a lookup table. The controller 300 controls the speed for each wheel by adjusting the power supply frequency of each in-wheel motor based on the determined frequency for each wheel. The controller 300 controls the steering for each wheel based on the determined steering angles for each wheel.

The controller 300 may further include an inverter. The inverter converts direct current (DC) power from the battery into alternating current (AC) power and supplies it to the in-wheel motors 200a, 200b, 200c, and 200d. The inverter may supply AC power to the respective in-wheel motors based on the specific power frequency for each wheel.

The vehicle 10 further has sensors (not illustrated) for obtaining information about the surrounding environment. The sensors may include a camera, a radar, a lidar, an ultrasonic sensor, or the like. For example, the camera obtains an image of the area surrounding the vehicle, and multiple cameras may be placed at the front/rear/side of the vehicle, but are not limited thereto. The camera may include a fish-eye camera, a wide-angle camera, or the like. For example, the ultrasonic sensor may detect an object around the vehicle and measure the direction, distance, or the like of the object. Multiple ultrasonic sensors may be disposed at the front/rear/side of the vehicle.

The vehicle 10 further include vehicle sensors (not illustrated) for obtaining driving information. Here, the driving information refers to a speed, acceleration, angular speed, yaw rate, steering angle, or the like of the vehicle. The vehicle sensors may include a speed sensor, an acceleration sensor, a gyro sensor, a yaw rate sensor, a steering angle sensor, or the like.

The configurations for controlling the speed and steering for each wheel of the vehicle can transmit or receive signals or data using various communication protocols existing in the vehicle. Here, the communication protocol may include at least one of a Controller Area Network (CAN), a Controller Area Network Flexible Data rate (CAN FD), a Local Interconnect Network (LIN), FlexRay, and Ethernet.

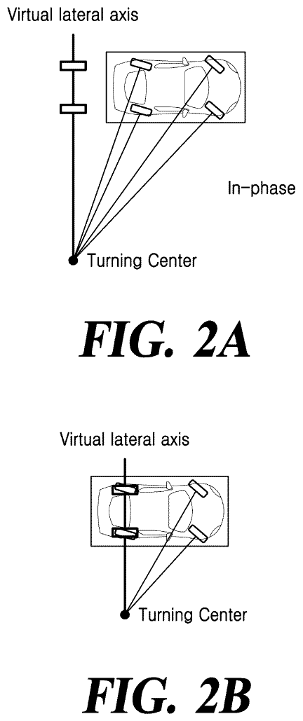

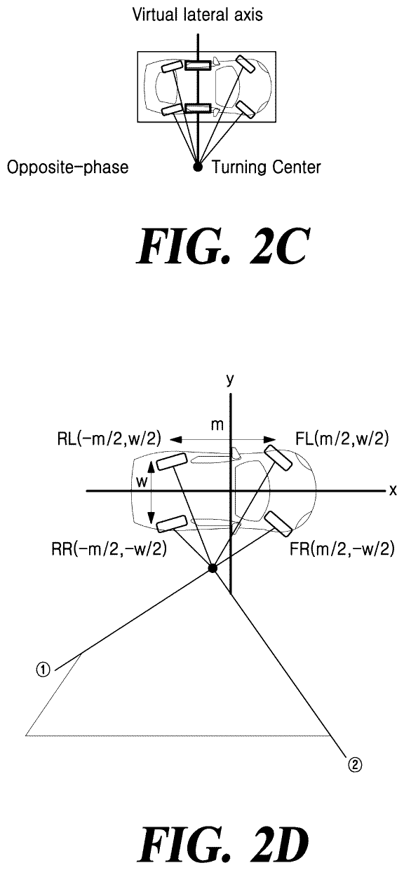

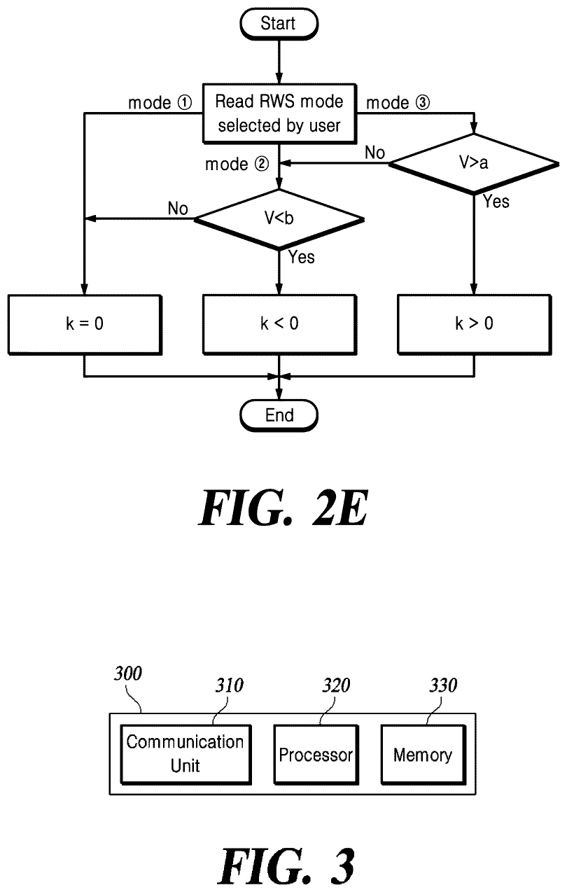

The turning centers of vehicles according to the steering situations for each wheel are described with reference to FIG. 2A, FIG. 2B and FIG. 2C. FIG. 2A illustrates the turning center of a vehicle with a RWS system when the rear-wheel steering angle is in-phase with, that is, in the same direction as the front-wheel steering angle. The front and rear wheels may be controlled in-phase at high speeds to improve the driving stability of the vehicle. FIG. 2B illustrates the turning center of a vehicle without a RWS system, i.e., a vehicle with front-wheel steering only. FIG. 2C shows the turning center of the vehicle with a RWS system when the rear-wheel steering angle is in opposite-phase, that is, in the opposite direction of the front-wheel steering angle. The front and rear wheels may be controlled in opposite-phase at low speeds to reduce the turning radius of the vehicle and thereby improve maneuverability.

In FIGS. 2A, 2B, and 2C, a virtual lateral axis is additionally illustrated to aid in understanding the rotational dynamics of the vehicle during steering. This axis is a conceptual line that passes through the turning center and is perpendicular to the vehicle's direction of travel.

The virtual lateral axis serves as a dynamic reference axis that reflects how the vehicle rotates during turning, depending on the steering configuration. In contrast to a conventional fixed lateral axis that bisects the wheelbase, this axis shifts dynamically according to the steering angle, vehicle speed, and whether rear-wheel steering (RWS) is applied.

For example, when the front and rear wheels are steered in-phase as shown in FIG. 2A, the turning center moves farther behind the vehicle, and the virtual lateral axis also shifts accordingly. Conversely, in the opposite-phase RWS scenario of FIG. 2C, the turning center shifts closer to the vehicle, resulting in a tighter turning radius and a different virtual lateral axis position.

This concept of a virtual lateral axis is particularly useful for analyzing vehicle stability and maneuverability under different steering conditions. It is not a physical or fixed structure but a dynamic geometric reference that assists in control logic and path prediction in steering systems.

As used herein, the term “virtual lateral axis” refers to a conceptual axis that passes through the turning center of the vehicle and is perpendicular to the vehicle's direction of movement. This axis varies in position depending on real-time steering parameters and is used as a dynamic reference for understanding and analyzing the rotational behavior of the vehicle.

With reference to FIG. 2D, an example of a process of calculating the center of turning of a vehicle based on steering angles of front and rear wheels will be described. With the center of a vehicle as a reference point, a coordinate where the x-axis is in the longitudinal direction of the vehicle and the y-axis is in the transverse direction of the vehicle is assumed.

Referring to FIG. 2D, the front left (FL) wheel of the vehicle has a coordinate of (m/2, w/2), the front right (FR) wheel has a coordinate of (m/2, −w/2), the rear left (RL) wheel has a coordinate of (−m/2, w/2), and the rear right (RR) wheel has a coordinate of (−m/2, −w/2). Here, “m” denotes a wheel base of the vehicle, and “w” denotes a tread of the vehicle. The hatched trapezoid represents an area where the center of turning of the vehicle may exist based on steering angles of the front/rear wheels when the vehicle turns to the right.

When a steering angle of the FR wheel is given as α and a steering angle of the RR wheel is given as β, the center of turning of the vehicle may be at the intersection point of straight lines \textcircled{1} and \textcircled{2}. Here, the equation of each of straight lines \textcircled{1} and \textcircled{2} may be as shown in Equation 1, and the x and y coordinates of the intersection point of the two straight lines may be calculated as shown in Equation 2.

$$line y = tan ( \frac{π}{2} + α ) x - tan ( \frac{π}{2} + α ) * \frac{m}{2} - \frac{w}{2} , \qquad ( Equation 1 )$$

$$line y = tan ( \frac{π}{2} + β ) x + tan ( \frac{π}{2} + β ) * \frac{m}{2} - \frac{w}{2}$$

$$x = \frac{m}{2} * \frac{tan ( \frac{π}{2} + α ) + tan ( \frac{π}{2} + β )}{tan ( \frac{π}{2} + α ) - tan ( \frac{π}{2} + β )} , \qquad ( Equation 2 )$$

$$y = m * \frac{tan ( \frac{π}{2} + α ) * tan ( \frac{π}{2} + β )}{tan ( \frac{π}{2} + α ) - tan ( \frac{π}{2} + β )} - \frac{w}{2}$$

FIG. 2E is a flowchart illustrating a process for determining whether to activate a rear wheel steering (RWS) function and selecting a steering direction (in-phase or opposite-phase), according to one embodiment of the present disclosure.

In a vehicle equipped with an RWS system, the rear wheel steering angle can be configured either proportionally to the front wheel steering angle or based on predefined conditions such as vehicle speed and user settings. As illustrated in FIG. 2E, the activation and direction of the RWS function are determined based on user input and vehicle speed.

The RWS function may be selectively activated through a graphical user interface (GUI), allowing the user to choose among the following three modes: \textcircled{1} RWS is disabled, \textcircled{2} RWS is enabled only for parking maneuvers (low-speed opposite-phase steering), and \textcircled{3} RWS is enabled for both high-speed and parking maneuvers (speed-dependent in-phase/opposite-phase control).

First, the system determines the RWS mode selected by the user.

If the selected mode is (1) (RWS disabled), the system sets the proportional constant k=0, indicating that rear wheel steering is not performed.

If the selected mode is \textcircled{2} or \textcircled{3}, the system evaluates the current vehicle speed V to determine the steering direction.

If the vehicle speed V is greater than a predefined threshold a, which is the minimum speed for in-phase control, the system sets k>0, indicating that in-phase steering is applied.

If the speed V does not exceed a, the system further checks whether V<b, where b is the maximum speed threshold for opposite-phase control.

If V<b, opposite-phase steering is applied, and k<0 is set.

Otherwise, the RWS function is not activated, and k=0.

In this way, the system dynamically adjusts the rear wheel steering behavior based on both user preferences and real-time driving conditions. The approach enables enhanced maneuverability at low speeds and improved driving stability at high speeds by appropriately switching between in-phase and opposite-phase control.

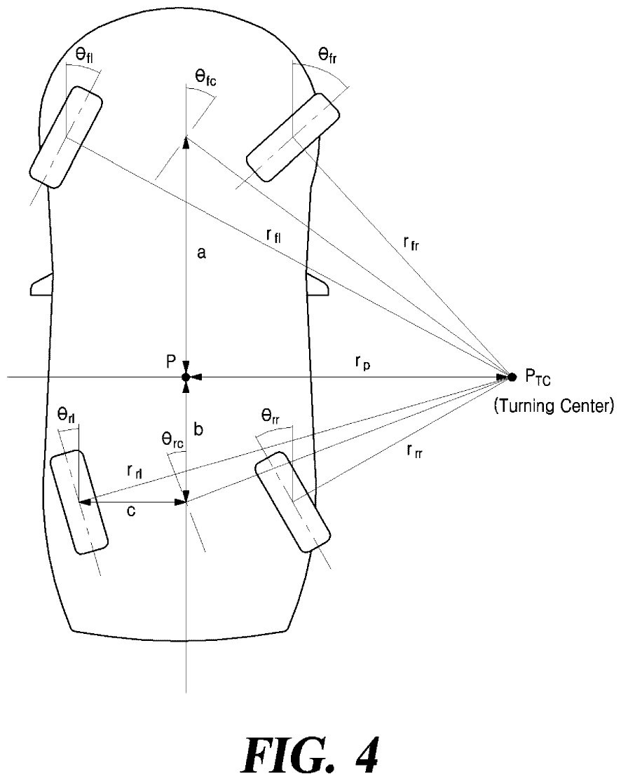

FIG. 3 is a block diagram of an apparatus (hereinafter, referred to as an “apparatus for controlling a speed and steering for each wheel”) for controlling a speed and steering for each wheel of a vehicle according to one embodiment of the present disclosure. The apparatus 300 for controlling a speed and steering for each wheel is identical to the controller 300 of FIG. 1.

Referring to FIG. 3, the apparatus 300 for controlling a speed and steering for each wheel according to one embodiment of the present disclosure includes a communication unit 310, a processor 320, and a memory 330. The apparatus 300 for controlling a speed and steering for each wheel can be implemented inside a vehicle.

The communication unit 310 may transmit and receive signals or data with other components in the vehicle using various communication protocols existing in the vehicle. For example, the communication unit 310 may receive images of the area surrounding the vehicle or obstacle detection information from a camera and an ultrasonic sensor. For example, the communication unit 310 may receive driving information including the speed, acceleration, angular speed, yaw rate, steering angle, or the like of the vehicle from vehicle sensors. For example, the communication unit 310 may transmit a control signal for steering, braking, traveling, or shifting to the corresponding controller.

The communication unit 310 may transmit and receive signals or data with a terminal, server, or system outside the vehicle using various wireless communication methods. Here, the wireless communication methods may include Wireless LAN (WLAN), Wireless-Fidelity (Wi-Fi), Wireless Fidelity (Wi-Fi) Direct, Digital Living Network Alliance (DLNA), a Wireless Broadband (WiBro), World Interoperability for Microwave Access (WiMAX), High Speed Downlink Packet Access (HSDPA), High Speed Uplink Packet Access (HSUPA), Long Term Evolution (LTE), 5G New Radio (NR), Bluetooth Low Energy (BLE), Near Field Communication (NFC), ultra-wideband (UWB) communication, or the like.

The processor 320 performs overall control so that the apparatus 300 for controlling a speed and steering for each wheel can perform a function thereof normally. The processor 320 may be implemented in the form of hardware, software, or a combined form of hardware and software. The processor 320 may perform various data processing and determinations using information stored in the memory 330. In one example, the processor 320 may be configured to perform a series of commands stored in the memory 330.

The processor 320 controls the speed and steering for each wheel based on a steering wheel rotation angle and the vehicle speed. The processor 320 controls the speed and steering of each wheel based on the steering angle and the vehicle speed. In the case of the vehicle 10 without a rear wheel steering system, the processor 320 may control only the speed of each wheel.

The processor 320 determines the steering angle and frequency for each wheel based on the input steering wheel rotation angle, using the lookup table. Here, the lookup table may be configured as a data structure that stores, for each of a plurality of input steering angles, a corresponding record comprising wheel-specific parameters. Specifically, each record of the lookup table includes a steering angle factor and a frequency factor for each wheel of the vehicle, such as the front-left, front-right, rear-left, and rear-right wheels. The lookup table is pre-generated by calculating, for each of a plurality of input steering angles, a steering angle factor and a frequency factor for each wheel, considering the vehicle's specifications. Here, the input steering angle θᵢₙ refers to the front wheel steering angle θ_{fc}. The processor 320 may reference the lookup table to retrieve the corresponding steering angle factor and frequency factor for each wheel based on the input steering angle, and determine the steering angle and the frequency for each wheel accordingly.

The processor 320 may generate the lookup table in advance and store the lookup table in memory 330.

First, the process of generating the lookup table is explained.

The processor 320 can obtain a steering angle θ from a steering wheel rotation angle α. The steering wheel rotation angle α refers to a rotation angle of a steering wheel. The steering angle θ refers to a rotation angle of the wheel. The steering angle θ may be derived from the steering wheel rotation angle α using a steering gear ratio or steering ratio, depending on the vehicle's specifications.

In the case of the vehicle 10 with a rear wheel steering system, the steering angle of the rear wheel may be determined based on the steering angle of the front wheel and the vehicle speed. For example, when the vehicle travels at high speed (for example, exceeding 60 km/h), the rear wheel may be controlled in the same phase as that of the front wheel, and the steering angle of the rear wheel may be determined by multiplying the steering angle of the front wheels by a predetermined proportional constant k. For example, when the vehicle travels at low speed (for example, 60 km/h or less), the rear wheel may be controlled in the phase opposite to that of the front wheel, and the steering angle of the rear wheel may be determined by multiplying the steering angle of the front wheel by a predetermined proportional constant k.

Here, the proportional constant k can be predefined during a tuning process of vehicle development, and may be determined depending on whether the rear wheel steering system is used. For example, when the rear wheel steering system is not used, the proportional constant k may have a value of 0. For example, when the rear wheel is controlled in the same phase as that of the front wheel, the proportional constant k may have a positive value. For example, when the rear wheel is controlled in the phase opposite to that of the front wheel, the proportional constant k may have a negative value.

Some examples of the results of determining a front wheel steering angle θ_{fc} and a rear wheel steering angle θ_{rc} according to the steering wheel rotation angle α at the time of the opposite-phase control in the vehicle with the rear wheel steering system are illustrated in Table 1. At this time, a steering ratio is approximately 14:1, and the proportional constant k is −0.2.

TABLE 1

| Steering wheel | Front wheel | Rear wheel |
|---|---|---|
| rotation angle | steering angle | steering angle |
| α (degree) | θ_{fc} | θ_{rc} |
| 0 | 0 | 0 |
| 30 | −2.15 | 0.43 |
| 60 | −4.30 | 0.86 |
| 90 | −6.45 | 1.29 |
| 120 | −8.60 | 1.72 |
| 150 | −10.70 | 2.14 |

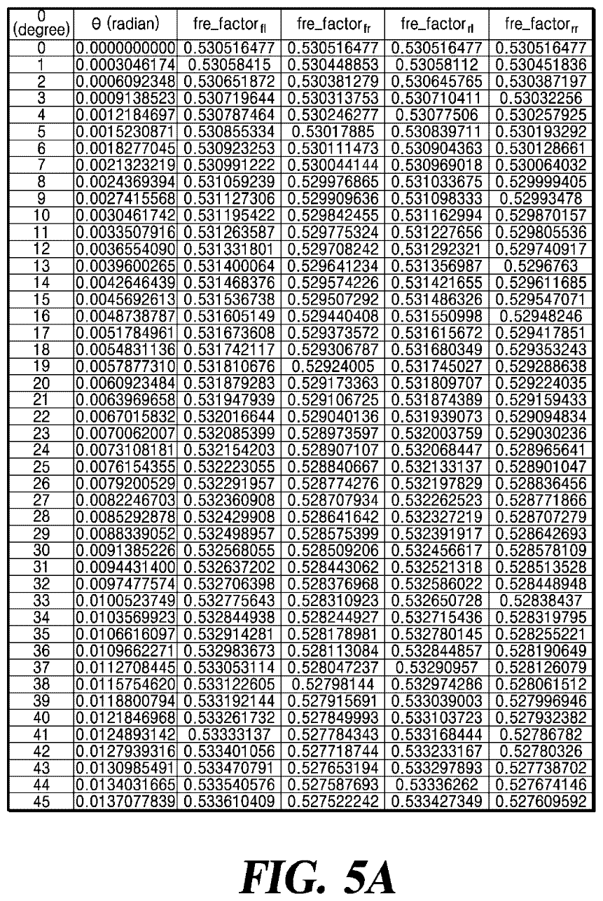

The processor 320 determines the steering angle for each wheel based on an input steering angle θᵢₙ. Here, the input steering angle θᵢₙ represents the front wheel steering angle θ_{fc}. The steering angle for each wheel can be determined as in Equation 3, and the determination of the steering angle for each wheel is explained with reference to FIG. 4.

$${r}_{p} = \frac{a}{tan {θ}_{i n}} \qquad ( Equation 3 )$$

$${θ}_{fl} = {tan}^{- 1} ( a / ( c + {r}_{p} ) ) = {tan}^{- 1} ( \frac{a * tan {θ}_{i n}}{a + c * tan {θ}_{i n}} ) = {ang\_factor}_{fl} ( {θ}_{i n} )$$

$${θ}_{fr} = {tan}^{- 1} ( a / ( - c + {r}_{p} ) ) = {tan}^{- 1} ( \frac{a * tan {θ}_{i n}}{a - c * tan {θ}_{i n}} ) = {ang\_factor}_{fr} ( {θ}_{i n} )$$

$${θ}_{rl} = {tan}^{- 1} ( b / ( c + {r}_{p} ) ) = {tan}^{- 1} ( \frac{b * tan k {θ}_{i n}}{b + c * tan k {θ}_{i n}} ) = {ang\_factor}_{rl} ( {θ}_{i n} )$$

$${θ}_{rr} = {tan}^{- 1} ( b / ( - c + {r}_{p} ) ) = {tan}^{- 1} ( \frac{b * tan k {θ}_{i n}}{b - c * tan k {θ}_{i n}} ) = {ang\_factor}_{rr} ( {θ}_{i n} )$$

Here, rₚ represents a turning radius of the vehicle, a and b represent the front and rear lengths of a wheel base, respectively, c represents half of a tread length of the vehicle, θ_{fl} represents a left front wheel steering angle, θ_{fr} represents a right front wheel steering angle, θᵣₗ represents a left rear wheel steering angle, and θᵣᵣ represents a right rear wheel steering angle. Here, ang_factor represents a steering angle factor for each wheel.

At this time, the processor 320 may determine a turning center P_{TC} using the front wheel steering angle θ_{fc} and the rear wheel steering angle θ_{rc}. For example, as shown in FIG. 4, the processor 320 may determine the turning center P_{TC} by calculating two normals based on the front wheel steering angle θ_{fc} and the rear wheel steering angle θ_{rc}, and then finding the intersection of these two normals.

The processor 320 determines the speed for each wheel based on the input steering angle θᵢₙ and the vehicle speed Vᵢₙ. Here, since the turning center P_{TC} is the same for all wheels, an angular speed ω_{c} of all wheels is also the same. The speed for each wheel is determined as the product of the turning radius for each wheel and the angular speed ω_{c}. For example, the speed for each wheel may be determined as shown in Equation 4, and determination of the speed for each wheel will be explained with reference to FIG. 4.

$${v}_{i n} = {ω}_{c} * {r}_{p} , {ω}_{c} = \frac{{v}_{i n}}{{r}_{p}} \qquad ( Equation 4 )$$

$${v}_{fl} = {ω}_{c} * {r}_{fl} = {v}_{i n} \sqrt{( tan {θ}_{i n}^{2} + {( \frac{tan {θ}_{i n}}{a} * ( c + \frac{a}{tan {θ}_{i n}} ) )}^{2} )}$$

$${v}_{fr} = {ω}_{c} * {r}_{fr} = {v}_{i n} \sqrt{( tan {θ}_{i n}^{2} + {( \frac{tan {θ}_{i n}}{a} * ( - c + \frac{a}{tan {θ}_{i n}} ) )}^{2} )}$$

$${v}_{rl} = {ω}_{c} * {r}_{rl} = {v}_{i n} \sqrt{( tan {θ}_{i n}^{2} + {( \frac{tan {θ}_{i n}}{b} * ( c + \frac{b}{tan {θ}_{i n}} ) )}^{2} )}$$

$${v}_{rr} = {ω}_{c} * {r}_{rr} = {v}_{i n} \sqrt{( tan {θ}_{i n}^{2} + {( \frac{tan {θ}_{i n}}{b} * ( - c + \frac{b}{tan {θ}_{i n}} ) )}^{2} )}$$

Here, Vᵢₙ represents an vehicle speed, ω_{c} represents the angular speed, rₚ represents the turning radius of the vehicle, θᵢₙ represents the input steering angle, v_{fl} represents a left front wheel speed, r_{fl} represents a turning radius of the left front wheel, v_{fr} represents a right front wheel speed, r_{fr} represents a turning radius of the right front wheel, vᵣₗ represents a left rear wheel speed, rᵣₗ represents a turning radius of the left rear wheel, vᵣᵣ represents a right rear wheel speed, and rᵣᵣ represents a turning radius of the right rear wheel.

The processor 320 determines the frequency for each wheel. The frequency for each wheel is determined based on a tire radius rₜᵢᵣₑ for each wheel and the speed for each wheel. Here, the tire radius rₜᵢᵣₑ of all wheels is assumed to be the same. For example, the frequency for each wheel may be determined as shown in Equation 5, and the determination of the frequency for each wheel will be explained with reference to FIG. 4.

$${v}_{fl} = {ω}_{fl} * {r}_{tire} = 2 π * {f}_{fl} * {r}_{tire} \qquad ( Equation 5 )$$

$$\begin{matrix}{f}_{fl} = \frac{{v}_{fl}}{2 π * {r}_{tire}} \\ = {v}_{i n} \frac{1}{2 π * {r}_{tire}} \sqrt{( tan {θ}_{i n}^{2} + {( \frac{tan {θ}_{i n}}{a} * ( c + \frac{a}{tan {θ}_{i n}} ) )}^{2} )} \\ = {v}_{i n} * {fre\_factor}_{fl} ( {θ}_{i n} )\end{matrix}$$

$$\begin{matrix}{f}_{fr} = \frac{{v}_{fr}}{2 π * {r}_{tire}} \\ = {v}_{i n} \frac{1}{2 π * {r}_{tire}} \sqrt{( tan {θ}_{i n}^{2} + {( \frac{tan {θ}_{i n}}{a} * ( - c + \frac{a}{tan {θ}_{i n}} ) )}^{2} )} \\ = {v}_{i n} * {fre\_factor}_{fr} ( {θ}_{i n} )\end{matrix}$$

$$\begin{matrix}{f}_{rl} = \frac{{v}_{rl}}{2 π * {r}_{tire}} \\ = {v}_{i n} \frac{1}{2 π * {r}_{tire}} \sqrt{( tan k {θ}_{i n}^{2} + {( \frac{tan k {θ}_{i n}}{b} * ( c + \frac{b}{tan k {θ}_{i n}} ) )}^{2} )} \\ = {v}_{i n} * {fre\_factor}_{rl} ( {θ}_{i n} )\end{matrix}$$

$$\begin{matrix}{f}_{rr} = \frac{{v}_{rr}}{2 π * {r}_{tire}} \\ = {v}_{i n} \frac{1}{2 π * {r}_{tire}} \sqrt{( tan k {θ}_{i n}^{2} + {( \frac{tan k {θ}_{i n}}{b} * ( - c + \frac{b}{tan k {θ}_{i n}} ) )}^{2} )} \\ = {v}_{i n} * {fre\_factor}_{rr} ( {θ}_{i n} )\end{matrix}$$

Here, f_{fl} represents a frequency of the left front wheel, for represents a frequency of the right front wheel, fᵣₗ represents a frequency of the left rear wheel, and fᵣᵣ represents a frequency of the right rear wheel. Here, fre_factor represents the frequency factor for each wheel.

The processor 320 generates the lookup table by determining the steering angle factor for each wheel and the frequency factor for each wheel in advance according to the input steering angle θᵢₙ. The generated lookup table may be stored in the memory 330.

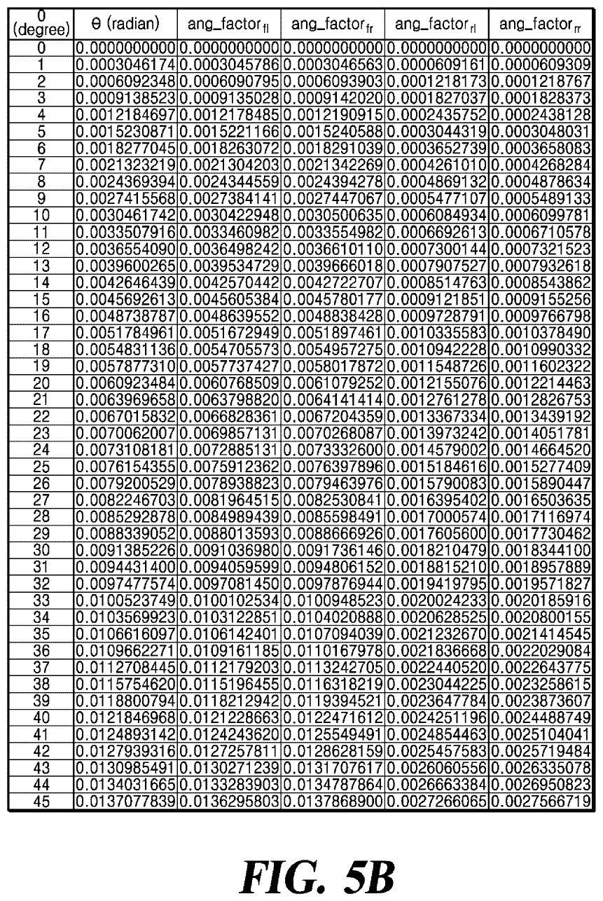

FIG. 5A and FIG. 5B are diagrams illustrating the lookup table according to one embodiment of the present disclosure. Referring to FIG. 5A and FIG. 5B, when the steering angle θ is given in 1° increments within a range of 0° to 45°, the corresponding values of the steering angle factor for each wheel and the frequency factor for each wheel are shown.

The processor 320 uses the lookup table to retrieve the frequency factor for each wheel and the steering angle factor for each wheel corresponding to the input steering angle, and determines a target frequency for each wheel and a target steering angle for each wheel based on the retrieved factors.

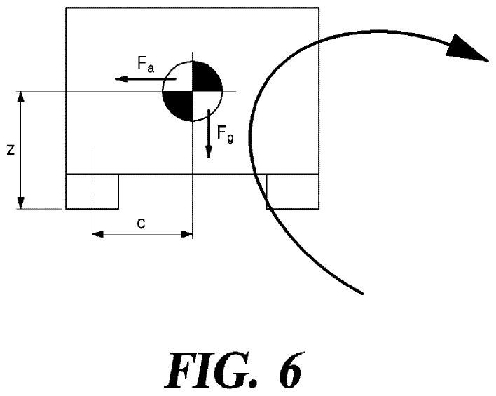

The processor 320 may multiply the vehicle speed vᵢₙ by the retrieved frequency factor for each wheel to determine the target frequency for each wheel. In this case, the processor 320 determines whether the vehicle speed vᵢₙ exceeds the limited speed vᵣₒₗₗₒᵥₑᵣ, and when the vehicle speed exceeds the limited speed, the processor adjusts the vehicle speed to the limited speed or less. Here, the limited speed refers to the maximum speed at which rollover does not occur according to the turning radius of the vehicle. When the vehicle is cornering, the rollover may occur if the sum of the moment caused by a centrifugal force Fₐ and the moment caused by gravity F_{g} becomes less than 0. For example, the limited speed vᵣₒₗₗₒᵥₑᵣ may be determined as shown in Equation 6, and the determination of the limited speed will be explained with reference to FIG. 6.

$$\sum = z * m * \frac{{v}_{i n}^{2}}{{r}_{p}} - c * m * g < 0 , {V}_{Rollover} = \sqrt{\frac{c * g * {r}_{p}}{Z}} \qquad ( Equation 6 )$$

Here, Σ is the sum of moments, z is the height from the ground to the center of the vehicle, c represents half of the tread length of the vehicle, m is the weight of the vehicle, g is the acceleration of gravity, rₚ is the turning radius of the vehicle, and vᵣₒₗₗₒᵥₑᵣ is the limited speed at which the vehicle does not roll over.

The processor 320 may determine the retrieved steering angle factor for each wheel as the target steering angle for each wheel.

The processor 320 controls a steering device, which steers each wheel of the vehicle, and the in-wheel motors mounted on each wheel, based on the target steering angle and target frequency for each wheel.

The processor 320 may output wheel-specific control values, determined based on the difference between the target and measured values for each wheel, to the corresponding steering device or in-wheel motor. For example, the processor 320 may employ feedback control, Proportional-Integral-Derivative (PID) control, or other control methods to ensure the measured values of the steering device or in-wheel motor reach the target values, but is not limited thereto.

To this end, the processor 320 may obtain a steering angle measured for each wheel and/or a frequency measured for each wheel using vehicle sensors (not illustrated).

The processor 320 may determine a steering angle control value for each wheel based on the target steering angle determined for each wheel and the steering angle measured for each wheel. For example, the processor 320 may determine a steering angle error between the target steering angle determined for each wheel and the measured steering angle for each wheel, and determine the steering angle control value for each wheel by summing the target steering angle determined for each wheel and the corresponding steering angle error. For example, the processor 320 may determine the steering angle control value for each wheel by compensating for the target steering angle through PID control based on the error between the target steering angle determined for each wheel and the measured steering angle for each wheel.

The processor 320 may determine a frequency control value for each wheel based on the target frequency determined for each wheel and the frequency measured for each wheel. For example, the processor 320 may determine a frequency error between the target frequency determined for each wheel and the measured frequency for each wheel, and determine the frequency control value for each wheel by summing the target frequency determined for each wheel and the corresponding frequency error for each wheel. For example, the processor 320 may determine the frequency control value for each wheel by compensating for the target frequency through PID control based on an error between the target frequency determined for each wheel and the measured frequency for each wheel.

The processor 320 applies the determined frequency control value for each wheel to the corresponding in-wheel motor. The processor 320 outputs the determined steering angle control value for each wheel to the corresponding steering device.

The memory 330 is a computer-readable recording medium and may include at least one of a random access memory (RAM), a read only memory (ROM), or a permanent mass storage device such as a disk drive. Here, ROM and a permanent mass storage device such as a disk drive may be included in the apparatus 300 for controlling a speed and steering for each wheel as a separate permanent storage device distinct from the memory 330.

The memory 330 may store an operating system and at least one program code. These software components may be loaded into the memory 330 from a computer-readable recording medium separate from the memory 330. The separate computer-readable recording medium may include a computer-readable recording medium such as a floppy drive, a disk, a tape, a DVD/CD-ROM drive, a memory card, or the like. In another embodiment, the software components may be loaded into the memory 330 via the communication unit 310 rather than a computer-readable recording medium. For example, the software components may be loaded into the memory 330 of the apparatus 300 for controlling a speed and steering for each wheel based on a computer program installed by files received via the communication unit 310.

The memory 330 may store commands executed by the processor 320, the lookup table (LUT), or the like, but is not limited thereto.

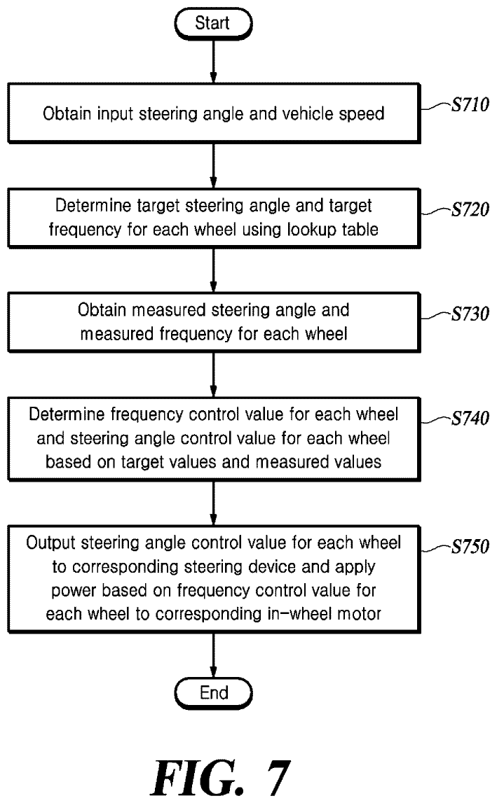

FIG. 7 is a flowchart of a method for controlling a speed and steering for each wheel of a vehicle according to one embodiment of the present disclosure.

Referring to FIG. 7, the method obtains the input steering angle and the vehicle speed (S710). The input steering angle may be determined from the steering wheel rotation angle input by the user.

The method uses a lookup table to determine target values for the steering angle for each wheel and the frequency for each wheel from the input steering angle and vehicle speed (S720). Here, the lookup table is generated by determining in advance the steering angle factor for each wheel and the frequency factor for each wheel corresponding to each input steering angle, considering the vehicle's specifications.

The method may determine the target steering angle for each wheel using the steering angle factor for each wheel corresponding to the input steering angle.

The method may determine the target frequency for each wheel using the frequency factor for each wheel corresponding to the input steering angle and the vehicle speed. In this case, the method determines whether the vehicle speed exceeds the limited speed, and when the vehicle speed exceeds the limited speed, adjusts the vehicle speed to the limited speed or less. Here, the limited speed refers to the maximum speed at which the rollover does not occur according to the turning radius of the vehicle.

The method obtains the measured values for the steering angle and frequency for each wheel using vehicle sensors (S730).

The method determines the control value for each wheel based on the difference between the target value for each wheel and the measured value for each wheel (S740). For example, the method may determine the control value for each wheel through feedback control, PID control, or the like. The method may determine the steering angle control value for each wheel based on the target steering angle determined for each wheel and the steering angle measured for each wheel. The method may determine the frequency control value for each wheel based on the target frequency determined for each wheel and the frequency measured for each wheel.

The method outputs the determined the steering angle control value for each wheel to the corresponding steering device, and applies power based on the determined frequency control value for each wheel to the corresponding in-wheel motor (S750).

The aforementioned processes are repeatedly performed while the vehicle 10 is in motion.

The apparatus or method according to an exemplary embodiment of the present disclosure may include the respective components provided to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations may include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) include instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Furthermore, the computer-readable recording medium can be distributed in computer systems connected via a network, wherein the computer-readable codes can be stored and executed in a distributed mode.

Although the steps in the respective flowcharts are described to be sequentially performed, they merely instantiate the technical idea of various exemplary embodiments of the present disclosure. Therefore, a person having ordinary skill in the pertinent art could perform the steps by changing the sequences described in the respective flowcharts or by performing two or more of the steps in parallel, and hence the steps in the respective flowcharts are not limited to the illustrated chronological sequences.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for controlling a vehicle, the method comprising:
obtaining, by a processor, an input steering angle and a vehicle speed of the vehicle;
determining, by the processor, a target steering angle and a target frequency for each wheel of the vehicle based on the input steering angle and the vehicle speed; and
controlling, by the processor, a steering device configured to perform steering of each wheel of the vehicle and motors mounted on each wheel of the vehicle, based on the target steering angle for each wheel and the target frequency for each wheel.

2. The method of claim 1, wherein the vehicle is an in-wheel motor vehicle, and the motors are in-wheel motors mounted on each wheel of the vehicle.

3. The method of claim 1, wherein the input steering angle is determined based on a steering wheel rotation angle input by a user.

4. The method of claim 1, wherein determining the target steering angle and the target frequency for each wheel is performed using a lookup table, and
wherein the lookup table is a predetermined table that is generated by determining, for each of a plurality of input steering angles, a steering angle factor for each wheel and a frequency factor for each wheel, considering the vehicle's specifications.

5. The method of claim 4, wherein the target steering angle for each wheel is determined using the steering angle factor for each wheel corresponding to the input steering angle, and
wherein the target frequency for each wheel is determined using the frequency factor for each wheel corresponding to the input steering angle and the vehicle speed.

6. The method of claim 1, wherein determining the target frequency for each wheel includes:
determining whether the vehicle speed exceeds a limit speed, and
setting the vehicle speed to the limit speed in response to determining that the vehicle speed exceeds the limit speed, and
wherein the limit speed is a maximum speed at which rollover does not occur according to a turning radius of the vehicle.

7. The method of claim 6, wherein controlling the steering device includes:
obtaining a steering angle measured for each wheel and a frequency measured for each wheel using sensors of the vehicle,
determining a steering angle control value for each wheel based on the target steering angle for each wheel and the steering angle measured for each wheel,
determining a frequency control value for each wheel based on the target frequency for each wheel and the frequency measured for each wheel, and
outputting the determined steering angle control value for each wheel to a corresponding steering device and applying power based on the determined frequency control value for each wheel to a corresponding in-wheel motor.

8. The method of claim 7, wherein determining the steering angle control value for each wheel includes:
determining a steering angle error between the target steering angle for each wheel and the measured steering angle for each wheel, and
determining the steering angle control value for each wheel by summing the target steering angle for each wheel and the corresponding steering angle error, and
wherein the determining of the frequency control value for each wheel includes
determining a frequency error between the target frequency for each wheel and the measured frequency for each wheel, and
determining the frequency control value for each wheel by summing the target frequency for each wheel and the corresponding frequency error.

9. The method of claim 7, wherein determining the steering angle control value for each wheel includes determining the steering angle control value for each wheel by compensating for the target steering angle by proportional-integral-derivative (PID) control based on an error between the target steering angle for each wheel and the measured steering angle for each wheel, and
wherein determining the frequency control value for each wheel includes determining the frequency control value for each wheel by compensating for the target frequency by PID control based on an error between the target frequency for each wheel and the measured frequency for each wheel.

10. A non-transitory computer readable medium containing program instructions executed by a processor, the computer readable medium comprising:
program instructions that obtain an input steering angle and a vehicle speed of a vehicle;
program instructions that determine a target steering angle and a target frequency for each wheel of the vehicle based on the input steering angle and the vehicle speed; and
program instructions that control a steering device configured to perform steering of each wheel of the vehicle and motors mounted on each wheel of the vehicle based on the target steering angle for each wheel and the target frequency for each wheel.

11. An apparatus for controlling a vehicle, the apparatus comprising:
a communication unit;
at least one processor; and
a memory operably coupled with the at least one processor,
wherein the at least one processor is configured to execute instructions to:
obtain an input steering angle and a vehicle speed of the vehicle,
determine a target steering angle and a target frequency for each wheel of the vehicle based on the input steering angle and the vehicle speed, and
control a steering device configured to perform the steering for each wheel of the vehicle and motors mounted on each wheel of the vehicle based on the target steering angle for each wheel and the target frequency for each wheel.

12. The apparatus of claim 1, wherein the vehicle is an in-wheel motor vehicle, and the motors are in-wheel motors mounted on each wheel of the vehicle.

13. The apparatus of claim 11, wherein the input steering angle is determined based on a steering wheel rotation angle input by a user.

14. The apparatus of claim 11, wherein determining the target steering angle and the target frequency for each wheel is performed using a lookup table, and
wherein the lookup table is pre-generated by determining, for each of a plurality of input steering angles, a steering angle factor for each wheel and a frequency factor for each wheel, considering the vehicle's specifications.

15. The apparatus of claim 14, wherein the target steering angle for each wheel is determined using the steering angle factor for each wheel corresponding to the input steering angle, and
wherein the target frequency for each wheel is determined using the frequency factor for each wheel corresponding to the input steering angle and the vehicle speed.

16. The apparatus of claim 11, wherein determining the target frequency for each wheel includes:
determining whether the vehicle speed exceeds a limit speed, and
setting the vehicle speed to the limit speed in response to determining that the vehicle speed exceeds the limit speed, and
wherein the limit speed is a maximum speed at which rollover does not occur according to a turning radius of the vehicle.

17. The apparatus of claim 16, wherein controlling the steering device includes:
obtaining a steering angle measured for each wheel and a frequency measured for each wheel using sensors of the vehicle,
determining a steering angle control value for each wheel based on the target steering angle for each wheel and the steering angle measured for each wheel, determining a frequency control value for each wheel based on the target frequency for each wheel and the frequency measured for each wheel, and
outputting the determined steering angle control value for each wheel to a corresponding steering device and applying power based on the determined frequency control value for each wheel to a corresponding in-wheel motor.

18. The apparatus of claim 17, wherein determining the steering angle control value for each wheel includes:
determining a steering angle error between the target steering angle for each wheel and the measured steering angle for each wheel, and
determining the steering angle control value for each wheel by summing the target steering angle for each wheel and the corresponding steering angle error, and
wherein the determining of the frequency control value for each wheel includes determining a frequency error between the target frequency for each wheel and the measured frequency for each wheel, and
determining the frequency control value for each wheel by summing the target frequency for each wheel and the corresponding frequency error

19. The apparatus of claim 17, wherein determining the steering angle control value for each wheel includes determining the steering angle control value for each wheel by compensating for the target steering angle by PID control based on an error between the target steering angle for each wheel and the measured steering angle for each wheel, and
wherein determining the frequency control value for each wheel includes determining the frequency control value for each wheel by compensating for the target frequency by PID control based on an error between the target frequency for each wheel and the measured frequency for each wheel.

20. A vehicle comprising the apparatus of claim 11.
